(19) United States
(12) Patent Application Publication
(10) Pub. No.: US 2017/0154392 A1
(43) Pub. Date: Jun. 1, 2017

(54) Location and Date/Time Constrained Content Windowing

(71) Applicant: Roopit Patel, Chicago, IL (US)

(72) Inventor: Roopit Patel, Chicago, IL (US)

(21) Appl. No.: 15/430,276

(22) Filed: Feb. 10, 2017

Related U.S. Application Data
(63) Continuation of application No. 14/945,111, filed on Nov. 18, 2015, now abandoned.
(60) Provisional application No. 62/081,294, filed on Nov. 18, 2014.

(51) Int. Cl. G06Q 50/18; G06F 17/30; G06Q 30/06

(52) U.S. Cl. CPC G06Q 50/184; G06Q 30/0601; G06F 17/3087

(57) ABSTRACT

The present invention is in the technical field of content windowing. Specifically, the present invention provides a content creator the ability to make content available at one or more particular locations and for one or more defined periods of time. A marketplace is further provided for content creators to make available content to be licensed by content licensors for providing content at one or more particular locations and for one or more defined periods of time.

The present invention claims priority as a continuation application of U.S. patent application Ser. No. 14/945,111, titled “Location and Date/Time Constrained Content Windowing,” filed Nov. 18, 2015, which claims priority to U.S. Provisional Pat. App. No. 62/081,294, titled “Location and Date/Time Constrained Content Windowing,” filed Nov. 18, 2014, and further claims priority to U.S. patent application Ser. No. 14/812,724, titled “Systems and Methods for Content Placement, Retrieval and Management Based on Geolocation and Other Parameters,” filed Jul. 29, 2015, which claims priority to U.S. Prov. Pat. App. No. 62/059,560, titled “Geo Located Content Placement, Retrieval and Management,” filed Oct. 3, 2014, each of which is incorporated by reference herein in its entirety.

### TECHNICAL FIELD

The present invention is in the technical field of content windowing. Specifically, the present invention provides a content creator the ability to make content available at one or more particular locations and for one or more defined periods of time. A marketplace is further provided for content creators to make available content to be licensed by content licensors for providing content at one or more particular locations and for one or more defined periods of time.

### BACKGROUND

Content “windowing” has been utilized for many years to restrict the providing of content to particular locations and for defined periods of time. For example, for many years the movie studio system has employed the system of content windowing, where movies are available at one place, exclusively, for a set period of time. Forcing exclusivity is critically important to the movie studio business as it drives consumer demand (only to where the movie is physically available), and therefore revenue.

The notion of content windowing persists today. For example, newly released movies are only available at movie theaters for some number of weeks. If one wishes to view the movie, they must visit a theater. After some number of weeks (or months), the movie moves from the movie theater “window” to the “download” window (Apple iTunes is one example of where a movie can be found in the “download” window). That movie is only available on Apple iTunes' service and nowhere else, driving revenue for Apple (and consequently, for the movie studio).

After the “download” window, the movie may become available in the “video on demand” window (it's available on Comcast xfinity, for example), then the “cable TV” window (shown on HBO, for example), then the “network TV” window (shown on NBC, for example), and finally, in the “home entertainment” window, where one can purchase a DVD of the movie at a physical store (Walmart, for example).

Content windowing—making content available only in a pre-determined location for a fixed duration of time to drive demand and revenue—requires the ability to exert control over each place the content is available. If a video on demand provider could simply download a movie from a download provider, and show it, exclusivity would be broken, and neither would derive nearly as much revenue.

A need, therefore, exists for providing content windowing in other contexts. Specifically, a need exists for taking the current model of content windowing and extending it to individuals and businesses that produce multi-media contact across various topical domains of consumer interest. More specifically, a need exists for providing content windowing of the multi-media content and making the content available via a mobile Internet browser or other like consumer application and pre-defined physical locations and/or at pre-defined dates and times, or for pre-defined fixed periods of time.

Moreover, a need further exists for a marketplace for multi-media content, where the multi-media content has pre-defined geographic area data and date/time data associated therewith, wherein a content licensor may license the multi-media content and provide the multi-media content to others a particular geographic location within the defined geographic area, and for a sub-period of time within the defined period of time.

### SUMMARY OF THE INVENTION

The present invention is in the technical field of content windowing. Specifically, the present invention provides a content creator the ability to make content available at one or more particular locations and for one or more defined periods of time. A marketplace is further provided for content creators to make available content to be licensed by content licensors for providing content at one or more particular locations and for one or more defined periods of time.

Specifically, the present invention is a technology allowing individuals representing physical locations to purchase exclusive rights to content of all kinds that can be consumed (retrieved, viewed, listened to, etc.) only at an established location for a fixed duration of time. This invention is location and date/time constrained content windowing.

Content creators make their content available at a marketplace. Physical locations (retailers, restaurants, etc.) wishing to drive consumers to their location (by virtue of the availability of exclusive content only retrievable at that location) can use the marketplace to purchase a license to this content. This content is only available at that location via a mobile browser and/or application for a pre-determined period of time.

To this end, in an embodiment of the present invention, a method of providing multi-media content is provided. The method comprises the steps of: creating multi-media content; providing the multi-media content to others via a network at a pre-defined physical location and for pre-defined periods of time.

In an alternate embodiment of the present invention, a method for providing a multi-media content marketplace is provided. The method comprises a steps of: creating multi-media content; defining a geographic area for providing the multi-media content to others and a period of time; offering the multi-media content to a content licensor for displaying the multi-media content at a geographic location within the geographic area, and for a sub-period of time within the period of time defined by the content creator.

It is, therefore, an advantage and objective of the present invention for taking the current model of content windowing and extending it to individuals and businesses that produce multi-media contact across various topical domains of consumer interest.

More specifically, it is an advantage and objective of the present invention to provide content windowing of the multi-media content and making the content available via a mobile Internet browser or other like consumer application and pre-defined physical locations and/or at pre-defined dates and times, or for pre-defined fixed periods of time.

Moreover, it is an advantage and objective of the present invention to provide a marketplace for multi-media content, where the multi-media content has pre-defined geographic area data and date/time data associated therewith, wherein a content licensor may license the multi-media content and provide the multi-media content to others a particular geographic location within the defined geographic area, and for a sub-period of time within the defined period of time.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 describes a process of listing content on the marketplace in an embodiment of the present invention.

FIG. 2 describes a process of using the marketplace to license content in an embodiment of the present invention.

FIG. 3 describes a process of retrieving content in the application in an embodiment of the present invention.

### DETAILED DESCRIPTION OF THE PRESENTLY PREFERRED EMBODIMENTS

The present invention is in the technical field of content windowing. Specifically, the present invention provides a content creator the ability to make content available at one or more particular locations and for one or more defined periods of time. A marketplace is further provided for content creators to make available content to be licensed by content licensors for providing content at one or more particular locations and for one or more defined periods of time.

The present invention may utilize the systems and methods, or portions thereof, disclosed in U.S. patent application Ser. No. 14/812,724, titled “Systems and Methods for Content Placement, Retrieval and Management Based on Geolocation and Other Parameters,” filed Jul. 29, 2015, which is incorporated herein by reference in its entirety.

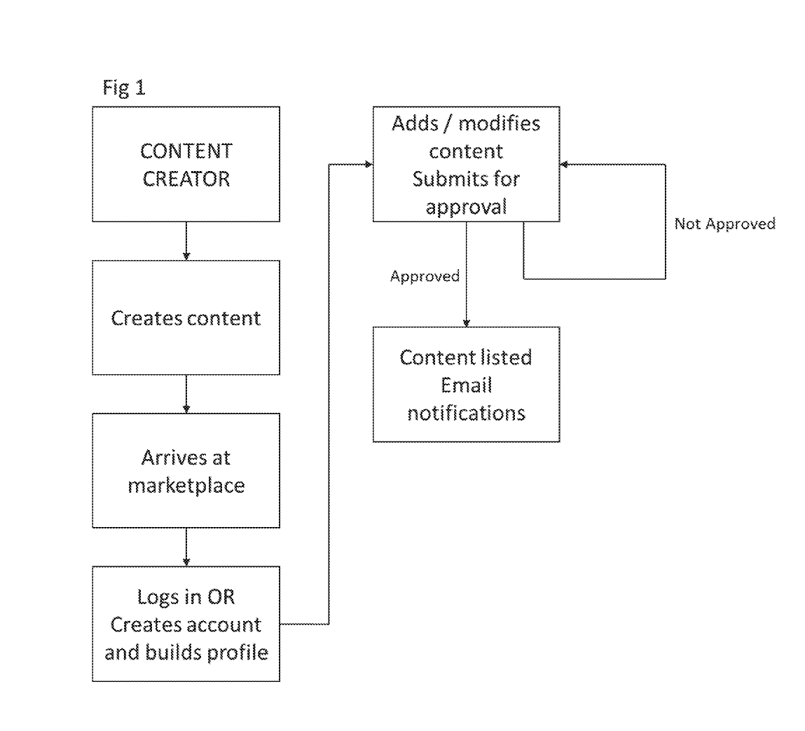

Referring now to the invention in more detail, in FIG. 1 the Content Creator makes one or more pieces of content. Content can manifest itself in any digital form:

Image

Text

Video

Audio

Digital File

In an embodiment, the content creator makes the content available or offers the content to others to make the same available at one or more particular geographic locations and for one or more defined periods of time. Specifically, the content creator may allow the content to be provided to others that are presently located in the particular geographic locations and within the defined periods of time, called a “window”.

In a preferred embodiment of the present invention, the Content Creator decides to utilize the Location and Date/Time Constrained Content Window marketplace (henceforth known as the “Marketplace”) to generate revenue with their content. The Content Creator visits the Marketplace. If they already have an account on the Marketplace, they log in. If not, the Content Creator creates an account.

After the Content Creator successfully creates an account, they may build a profile on the Marketplace describing themselves and/or their business.

After the Content Creator profile is complete, the Content Creator can make new content available on the Marketplace. When adding new content, the Content Creator provides the following information:

Content title

Content description

Date range of window when content is available to license

Price

Pricing format (purchase or auction)

Geography where content may be licensed

An indication if the Content Creator will help promote the Content Licensor's campaign, and the cost of that promotion, if applicable. A Content Licensor is an individual wishing to license a Content Creator's content for exclusive use within a location and date/time constrained window.

Once this information has been provided, the Content Creator submits the content for approval to the Marketplace. The Marketplace team receives an email notification that new content has been added, the team reviews the content and associated information, and if appropriate, approves it. The Content Creator receives an email notification that their content has been approved and the content is listed on the Marketplace to be licensed by a Content Licensor.

If there is a problem with the provided content, the Marketplace team can deny the content. An email notification is sent to the Content Creator, and they may modify the information provided about the Content and submit it for approval again. There is no limit to the number of times a Content Creator can submit content for approval.

The Content Creator can also modify content pending approval on the Marketplace. Once content has been approved, it cannot be modified—it can be deleted, only if it has not been licensed. If content has been licensed, it cannot be modified or deleted.

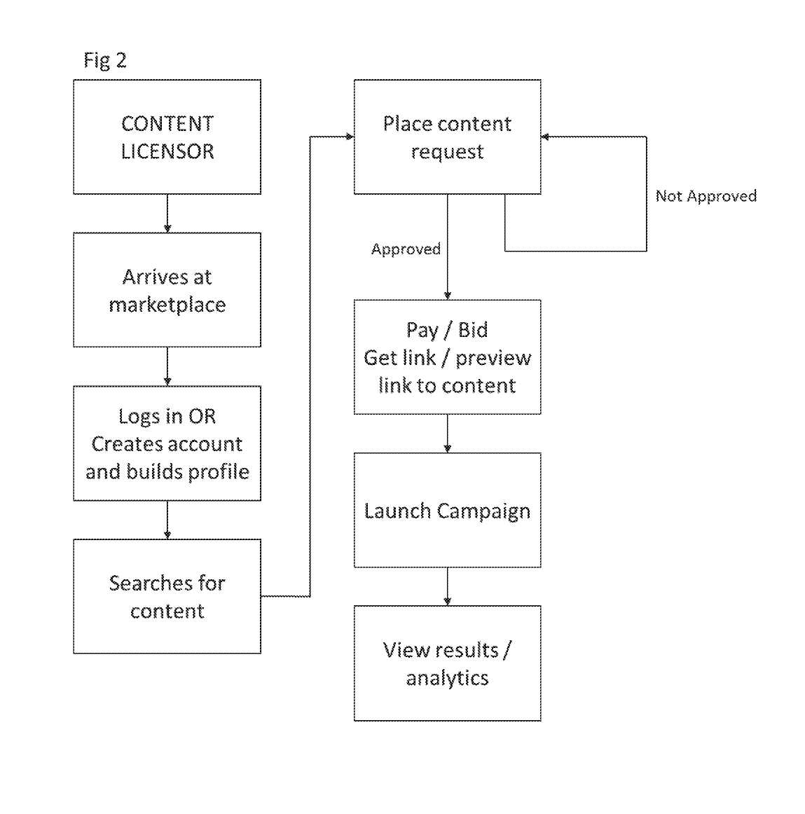

Referring now to the invention in more detail, in FIG. 2 a Content Licensor decides to drive people to their physical location by offering exclusive content provided by a Content Creator. The dates, times and geographical range for the content window are based on the terms set by the Content Creator.

The Content Licensor visits the Marketplace. If they already have an account on the Marketplace, they log in. If not, the Content Licensor creates an account.

After the Content Licensor successfully creates an account, they build a profile on the Marketplace describing themselves and/or their business.

The Content Licensor searches for content on the Marketplace. The Content Licensor is provided the following information about the content:

Content title

Content description

Date range of window when content is available to license

Price (the Marketplace team marks up the price of the content as provided by the Content Creator)

Pricing format (purchase or auction)

Geographical range where content may be licensed

An indication if the Content Creator will help promote the Content Licensor's campaign and the cost of that promotion, if applicable.

Historical analytics about the results driven by the Content Creator in general

Historical analytics about the results driven by individual pieces of content offered by the Content Creator

Once the Content Licensor finds one or more pieces of content, they can make a request to license it. The Content Licensor may provide the following information when making a request to license content:

Location description

Geography description (may be a single location or multiple locations)

Campaign description

Desired results of the campaign

Bid (if the pricing structure is an auction)

Number of other potential Content Licensors bidding for the content

The Marketplace team receives the request. If the request is approved, the Content Licensor must then pay for the content or make a monetary bid for the content (if the content is being offered in an auction format). If the request is denied, the Marketplace team provides a reason to the Content Licensor.

After a successful purchase, the Marketplace team pays the Content Creator the price they offered for the content.

Once the payment or auction is successful, the Content Licensor will receive a link to the content which is hosted on the Marketplace. The Content Licensor can download the Consumer Application to preview the content or may preview the content in their browser.

At a pre-determined time prior to the “opening” of the content window, the Content Licensor will commence a promotional campaign, to alert potential Content Consumers that the content will be available at their location for a specific length of time. The Content Creator may have offered, possibly for an additional fee, to help promote this campaign, too. If the Content Licensor has accepted an offer for the Content Creator to help promote the campaign, and provided payment (if necessary), the Content Creator will start the promotion prior to the “opening” of the content window.

Campaign promotion will continue until the content window “closes.” The Content Licensor will receive information about the success of the campaign (results/analytics) at the Marketplace. The information they will receive includes:

Number of times the content was viewed (retrieved) (when and exactly where)

Number of times the content was shared and where (when and exactly where)

Number of times the content was commented on (when and exactly where)

Aggregate information concerning the demographics of the individuals who retrieved, shared, and commented on the content

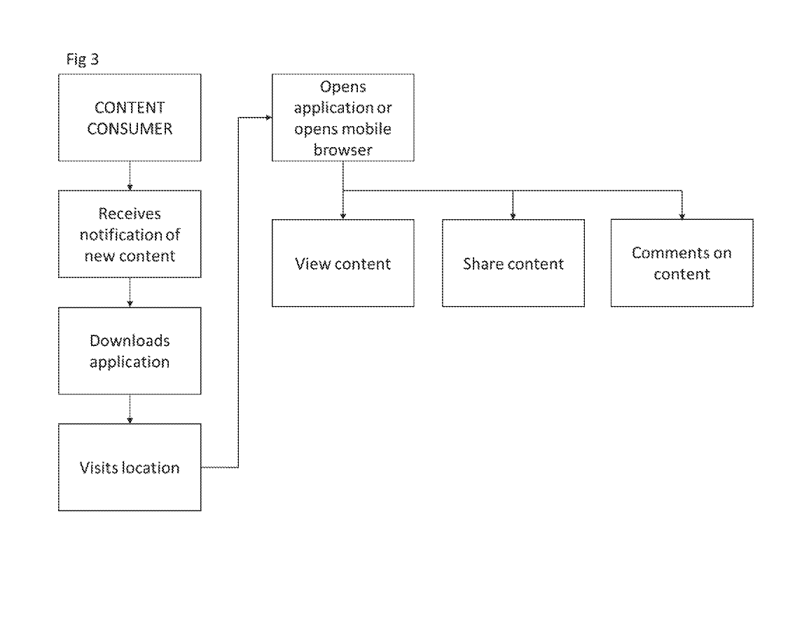

Referring now to the invention in more detail, in FIG. 3, the Content Consumer receives notification that new content is available. This notification can come in a wide variety of methods, including via email, SMS, one or more social networks, or via a notification from the Consumer Application. The notification may come prior to when the content window “opens” or while the content window is “open.” Most often, the notification will come with a link that, when viewed in the Consumer Application or a browser, within the pre-set geographic range of the physical location, will show the content.

If the Content Consumer attempts to view the content, via the provided link, before the content window “opens,” they will be presented with a message stating that the content is not yet available (they will be told when the content will be available). If they attempt to view the content before the window “opens” and are outside the physical geographic range for that content, they will also be notified that they are out of range for that content (they will be told where to go to retrieve the content after the window “opens.”) Specifically, to view or otherwise experience the content, the geographic location of the Content Consumer's mobile device is compared to the specific defined geographic location information of the content. If the Content Consumer's mobile device is not within the range of the defined geographic location information of the content, then the Content Consumer will be notified, as stated above.

Even if the content is not yet available, and/or if they the Content Consumer is out of geographic range, the Content Consumer will be able to share the link to the content via email, SMS, or on various social networks.

If the Content Consumer attempts to view the content, and the content window is “open” yet they are not within the geographic range of the specific physical location, the Content Consumer will see statistics about the content, but not the content itself. The statistics they will see are:

Number of times the content has been retrieved

Number of times the content has been shared

Number of times the content has been commented on, and the comments

Where the content is located

How long the content window will be “open”

If the content is available (the content window is “open”) and they are within the specified physical geographic range for that content, the content will be displayed, either in the Consumer Application or within a browser. Content Consumers can view the content, share the content via SMS, email, or on a variety of social networks. Content Consumers can also leave a comment on the content.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A method of providing multi-media content comprising the steps of:
creating multi-media content; and
providing the multi-media content to others via a network at a pre-defined physical location and for pre-defined periods of time.

2. A method for providing a multi-media content marketplace comprising the steps of:
creating multi-media content;
defining a geographic area for providing the multi-media content to others and a period of time; and
offering the multi-media content to a content licensor for displaying the multi-media content at a geographic location within the geographic area, and for a sub-period of time within the period of time defined by the content creator.
